(19) United States
(12) Patent Application Publication
(10) Pub. No.: US 2014/0358688 A1
(43) Pub. Date: Dec. 4, 2014

(54) METHODS AND SYSTEMS FOR TARGETED DISPLAYS AND INFORMATION

(71) Applicants: Luke D. Tuttle, Columbus, OH (US); Anthony K. Salyer, Gilbert, AZ (US); Steve Denton, Middletown, NJ (US)

(72) Inventors: Luke D. Tuttle, Columbus, OH (US); Anthony K. Salyer, Gilbert, AZ (US); Steve Denton, Middletown, NJ (US)

(21) Appl. No.: 14/138,019

(22) Filed: Dec. 21, 2013

Related U.S. Application Data
(60) Provisional application No. 61/828,456, filed on May 29, 2013.

(51) Int. Cl. G06Q 30/02

(52) U.S. Cl. CPC G06Q 30/0267
USPC 705/14.64

(57) ABSTRACT

In some examples, a system comprises a memory and at least one module executing on one or more computer processors to receive user behavior information and associate the user behavior information with at least one mobile user device identifier. The at least one module may further provide targeting information to an advertiser, the targeting information comprising the at least one mobile user device identifier, and transmit targeted information for display in an interface on the mobile user device based on the user behavior information associated with the at least one mobile user device identifier as defined in the specification.

### CLAIM OF PRIORITY

This patent application claims the benefit of priority, under 35 U.S.C. Section 119(e), to Tuttle et al, U.S. Provisional Patent Application Ser. No. 61/828,456, entitled “METHODS AND SYSTEMS FOR TARGETED DISPLAYS AND INFORMATION ,” filed on May 29, 2013 (Attorney Docket No. 2043.D39PRV), which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc., All Rights Reserved.

### BACKGROUND

Targeting has emerged as an effective way of advertising via the Internet. In some examples, targeting allows an advertiser to display an ad to a consumer after the consumer has left a website and begins browsing in another area on the Internet, for example. As the consumer proceeds to other websites, advertisements (or other information) may be provided to the user by the advertiser on the other websites.

To target potential customers, an advertiser stores information on a user's computer in the form of a cookie to indicate that the user visited a particular page. For example, if the user accesses a page relating to a particular DVD player, the advertiser's website may place a cookie corresponding to the web page on the user's computer. When the user leaves the web page, the cookie remains on the user's computer.

The advertiser purchases ad space from a publisher or an ad network. When the user accesses a web page associated with the publisher or ad network, the cookie is read from the user's computer. The publisher or ad network may then select an ad to be shown to the user according to the cookie information. Thus, the publisher or ad network may present an ad for the previously viewed DVD player, which may be clicked by the user to return to the advertiser's web page to purchase the DVD player.

While targeting can be quite effective, its reach is limited by the popularity of the publisher and/or size of the ad network. To reach more consumers, the advertiser contracts with multiple publishers and ad networks, thereby increasing the cost and complexity of the targeting. Use of multiple, unrelated publishers and ad networks creates additional problems, such as reduced control, overlapping reach among publishers and ad networks, and “overselling” due to a user receiving multiple ads for the same item via different publishers and ad networks.

### SUMMARY

Methods and apparatus for advertising according to various aspects of the present subject matter operate in conjunction with a targeting system, multiple publisher systems, at least one advertiser, and a user's computer. The targeting system provides targeting information to the advertiser for storage on the user computer. The targeting information may comprise identifiers for publisher systems authorized for targeting and an advertiser identifier. The targeting information may also receive user behavior information from a publisher system visited by the user after visiting the advertiser's web site. If the visited publisher system is an authorized publisher system, the targeting system may then transmit an advertisement corresponding to the advertiser identifier to the visited publisher system for presentation via the user's computer.

In some examples, a system comprises a memory and at least one module executing on one or more computer processors to receive user behavior information and associate the user behavior information with at least one mobile user device identifier. The at least one module may further provide targeting information to an advertiser, the targeting information comprising the at least one mobile user device identifier, and transmit targeted information for display in an interface on the mobile user device based on the user behavior information associated with the at least one mobile user device identifier (as defined herein).

The user behavior may be received from a visited publisher system, and the targeting information may further comprise multiple identifiers for multiple publisher systems for targeting by the advertiser.

In some examples, the memory stores the identifiers for the multiple publisher systems and the targeting information. The at least one module may be further configured to provide the targeting information to the advertiser, receive the user behavior information, and transmit the targeted information to the mobile user device.

In some examples, the targeting information includes code to request the multiple publisher system identifiers from the memory. In some examples, the multiple publisher systems comprise at least two unrelated ad networks.

Machine-readable media and systems associated with the method embodiments described below are also provided.

### BRIEF DESCRIPTION OF THE DRAWINGS

A more complete understanding of the present subject matter may be derived by referring to the detailed description and claims when considered in connection with the following illustrative figures. In the following figures, like reference numbers refer to similar elements and steps throughout the figures.

FIG. 1 is a block diagram of a system for advertising via computer networks.

FIG. 2 is a flow chart of a publisher system setup process.

FIG. 3 is a flow chart of an advertiser setup process.

FIG. 4 is a block diagram of targeting information being placed on a user computer.

FIGS. 5A-5D are flow charts of methods according to examples described herein.

FIG. 6 is a block diagram of providing targeted information to the user computer.

FIG. 7 is a flow chart of a process for providing targeted information to the user.

FIGS. 8-11 are flow charts for targeting information, according to example embodiments.

FIGS. 12-14 are flow charts for targeting information in affiliate sites, according to example embodiments.

FIG. 15 is a schematic of a machine, according to some examples of the present disclosure.

Elements and steps in the figures are illustrated for simplicity and clarity and have not necessarily been rendered according to any particular sequence. For example, steps that may be performed concurrently or in different order are illustrated in the figures to help to improve understanding of embodiments of the present subject matter.

### DETAILED DESCRIPTION OF EXEMPLARY EMBODIMENTS

The present subject matter may be described in terms of functional block components and various processing steps. Such functional blocks may be realized by any number of hardware or software components configured to perform the specified functions and achieve the various results. For example, the present subject matter may employ various computers, networks, and servers, e.g., servers, databases, webservers, the Internet, local networks, and the like, which may carry out a variety of functions. In addition, the present subject matter may be practiced in conjunction with any number of networks, types of information, or participants, and the system described is merely one exemplary application for the subject matter. Further, the present subject matter may employ any number of conventional techniques for transferring data, presenting information, storing information, and the like.

In some examples, targeted information or other content can be presented via a mobile device. More generally such information may be presented via an “interface”. An interface can exist in many forms. For example, the interface may interact with a user, in a functional or physical way, and may contribute and/or consume content. The interface may be associated with a device, but not necessarily so. The interface may be mouse driven, voice driven, or touch driven, for example. An associated device might be network enabled, but not necessarily so. The device or interface may be associated with local or proximate processing capability. In some examples, a physical interface may be presented by “smart” glasses (for example, Google glasses). In other embodiments, an interface may be intangible, such as a hologram. In further examples, the interface may be a non-mobile surface, such as a wall, table top, or side of an appliance. In other examples, an interface may be provided in a kiosk, or by a surface or device inside a motor vehicle, for example.

In some examples, targeted information or other content may be associated with a “location determination” of a user. This term includes detecting a user's presence or location. It may involve active sensing (for example, an accelerometer or other sensor) or a passive identification (for example, RFID). Location identification can be used as a trigger to present targeted information or other content in an interface

Targeted information or other content may include “consumable” information or “non-consumable” information (for example, metadata). Consumable examples can be displayed, emailed, pushed, or included in a text message. The information may include tiles, social media, digital data, physical (billboard) embodiments, audio files, commercial art, smart advertisements and so forth.

Viewed broadly, a “device” is any physical object which is capable of being a communication device or can present an interface. The device may be associated with local computational or remote computational functionality.

In some examples, targeted information may include an advertisement or “ad content”. Ad content may include promotional information which characterizes this information from general content. A “promotion” in ad content need not be tied to commerce, or payment, or a transaction, but will usually be associated with receipt of some kind of value. The value could relate to a good or a service (or hybrid of same)

The presentation of the targeted information may seek to extend on-line user “sessions”. In a multi-device world, the conventional definition of a session is becoming increasingly inapplicable. Viewed more broadly, a session in this disclosure includes the idea that the user is trying to achieve a particular task, with that task potentially spread over multiple devices and extended time period. The user could pick up a session on a different device, or after a lapse of time, and so forth. A user could have many parallel sessions going on simultaneously, for example. A session may include user phases, such as a discovery phase, an exploratory phase, a follow-up phase, and so forth. Sessions may be assessed or tied to a success metric, such as a “Bid-Buy-Offer-Watch-Ask seller question” (BBOWA) metric, for example.

The examples discussed above merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

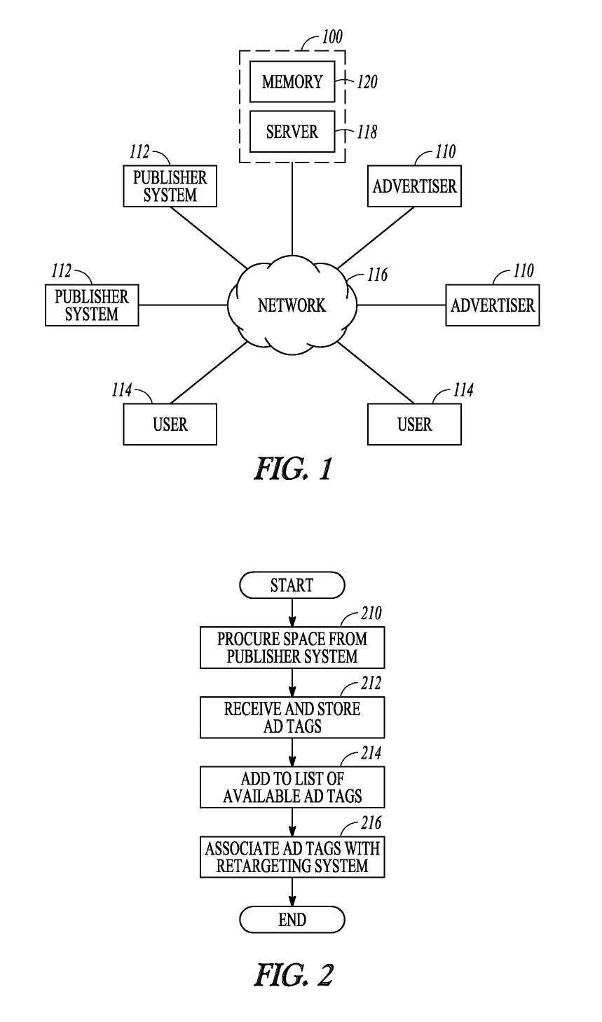

Methods and apparatus for delivering information via computer networks according to various aspects of the present subject matter operate in conjunction with computers connected via a network, such as the Internet. The computer may deliver targeted advertisements or other selected information to users via the network. Referring to FIG. 1, a targeting system 100, according to various aspects of the present subject matter, operates in conjunction with one or more advertisers 110 and one or more publisher systems 112 connected via a network 116. The targeting system 100 receives information for display to users 114 from the advertiser 110, and provides the information to users 114 via the publisher system 112 to target the users 114 according to selected criteria. Targeting permits the advertiser 110 to display an ad to a user 114 after the user 114 has left a website (for example the website of the advertiser 110, or other websites associated with the publisher systems 112). The present targeting system 100 enables advertisers 110 to place targeted ads to multiple users 114 across multiple publisher systems 112 through a single interface.

The advertisers 110 provide information to be viewed by the users 114. The advertisers 110 may comprise any appropriate systems or parties, such as political sources or vendors of commercial goods or services. Similarly, the information to be provided may comprise any suitable information, such as advertisements relating to goods or services or politically-oriented information. In this specification, the term “information” may include any information desired to be conveyed to a user 114. In the present embodiment, the information comprises advertisements encoded in an electronic format for transfer and presentation via the computer network 116. Further, the term “advertiser” generally includes an entity that wishes to convey information to a user even outside of an advertising context, per se. Further, the term “publisher” generally includes an entity that wishes to publish information to a user even outside an advertising context, per se. The term “targeting information” to a user may also include “targeting” information to a user in the sense that the targeted information is an initiation of information, as opposed to a re-initiation of same.

The publisher system 112 receives the information and presents it to the user 114. The publisher system 112 may comprise any suitable systems for receiving the information and presenting it to the users 114. In one embodiment, the publisher systems 112 comprise commercial websites that present advertisements to users 114 in exchange for compensation. For example, the publisher system 112 may comprise search engines, Internet publications, electronic news outlets, commercial websites, personal websites, online matchmaking services, and the like. The publisher system 112 may also include any systems or elements for transferring the information to the user 114, such as a conventional ad server. In the present embodiment, the publisher systems 112 may include web content publishers, such as operations that publish information for consumption by users 114 on the Internet. The publisher systems 112 may also include ad networks, such as conventional ad networks or other information intermediaries that serve as agencies between groups of web sites or other web content publishers desiring to host advertisements and advertisers 110 or groups wishing to run advertisements on those sites.

The targeting system 100 facilitates the transfer of information from the advertisers 110 to the users 114 via the publisher systems 112. The targeting system 100 may comprise any suitable system for providing the advertiser 110 information to the publisher system 112, such as an automated system connected to the publisher systems 112 and the advertisers 110 through a medium like the Internet or other computer network 116. The targeting system 100 may provide information to users 114 based on behavioral marketing concepts. The targeting system 100 may target users 114 for marketing efforts according to their behavior, as opposed to by the content of information they receive via the computer network 116 system (for example, based on clickstream data and IP information).

In particular, the targeting system 100 may perform targeting by observing a user 114's behavior while receiving information from the publisher systems 112 or advertisers 110, such as while visiting an advertiser 110's website. The targeting system 100 may then deliver targeted messages to the user 114 after the user 114 moves on to other subject matter, for example by visiting another publisher system 112's website without buying a product at the original website.

The targeting system 100 may comprise any suitable system to perform the targeting. For example, the targeting system 100 may comprise a server 118 having access to a database in a memory 120, such as a conventional hard drive array, optical storage system, or the like. The server 118 communicates with the advertisers 110 and publisher systems 112 to set up the targeting services and provide the targeted information to the users 114 via the publisher systems 112. In the present embodiment, the server 118 provides the targeting information to the advertiser 110 to be placed on the user 114's computer, receives behavior information regarding the user 114 from various publisher systems 112, and transmits advertisements or other information to the publisher systems 112 visited by the user 114 for presentation to the user 114. In addition, the server 118 may perform ancillary tasks, such as generating reports, invoices, and the like.

The database accessed by the server 118 may store any suitable information, such as advertisements, and information regarding the various publisher systems 112 including identifiers, advertiser 110 and publisher system 112 account information, reports, and the like. The targeting system 100 suitably operates in conjunction with software stored on a medium to cause the server 118 and other components of the targeting system 100 to operate.

The targeting system 100 may provide targeting according to any criteria, such as according to settings selected by multiple advertisers 110 and/or parameters set by the targeting system 100. Further, the targeting system 100 may deliver the information from the advertisers 110 to the users 114 via multiple unrelated publisher systems 112. Consequently, the targeting system 100 can provide targeting services to advertisers 110 across a broad range of networks and publishers through a single interface, such as an advertiser account interface provided to the advertiser 110 by the targeting system 100. In addition, the targeting system 100 can increase the effectiveness of the targeting services, for example by controlling the frequency with which users 114 are exposed to particular information, such as an advertisement. The targeting system 100 may also reduce the overall cost of the targeting process, reach more potential customers through the multiple publisher systems 112, provide flexibility and ease of use to advertisers 110, and/or improve its efficiency.

To perform the targeting operations, the targeting system 100 may be configured according to parameters set by the advertisers 110, default settings, an administrator of the targeting system 100, or other parties. For example, the targeting system 100 may store and access information relating to one or more publisher systems 112 and advertisers 110. In one embodiment, the targeting system 100 database includes information relating to multiple publisher systems 112 that agree to post advertisements for the advertisers 110. The publisher systems 112 may be selected or otherwise associated with the targeting system 100, for example via ownership, subscription, contract, or other relationship.

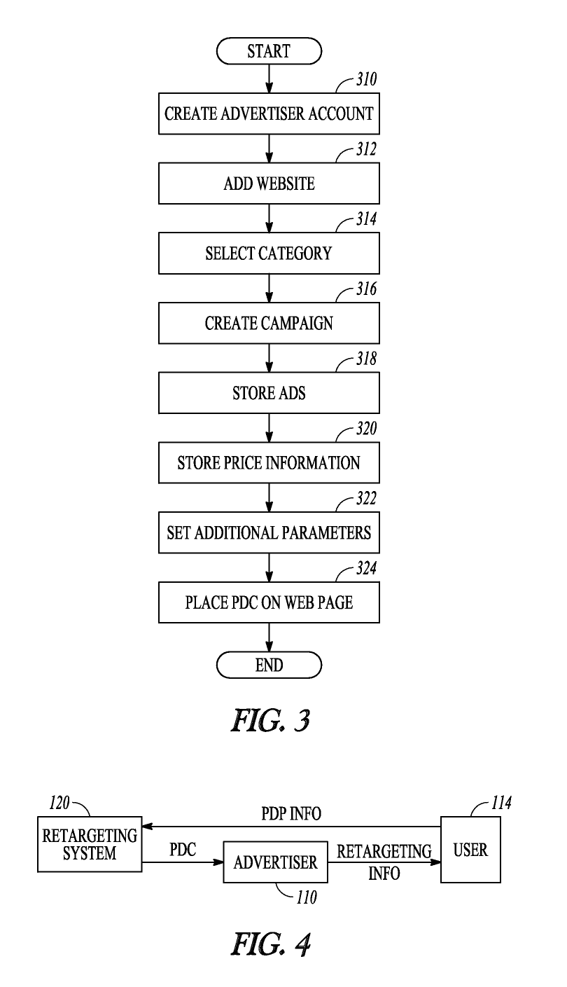

The publisher system 112 may provide advertising or other information transmission opportunities to the advertisers 110 via the targeting system 100. The publisher system 112 may be configured to identify targeting opportunities and deliver appropriate information. In the present embodiment, referring to FIG. 2, the operator of the targeting system 100 may procure advertising space from the publisher systems 112 (operation 210), such as by directly purchasing from a publisher, purchasing through an advertising network, or other appropriate methods. For Internet web advertising, the advertising purchases may be represented by ad tags generated by the publisher system 112 and provided to the targeting system 100. The ad tags are unique for each publisher system 112, and may correspond to particular electronic publications, websites, and/or advertising locations, types, and/or sizes.

In the present embodiment, the ad tags comprise computer code, such as HTML code. Each ad tag may include any appropriate information, such as website information, ad types, and pixel data. For example, the ad tags may include the publisher system 112's name, publisher system 112's network ID, the ad type (e.g., skyscraper, popunders, etc.), an age or duration of the ad tag, and pricing information.

The targeting database may store the ad tags and any other information, such as identification information for the various publisher systems 112, as well as terms and parameters for posting the advertisements (operation 212). In the present embodiment, information relating to the publisher systems 112 is stored in the database and associated with a publisher system 112 ID for each publishing system. The publisher system 112 information may comprise any appropriate information, such as the name of the publisher or network, an identification code assigned to the publisher system 112, one or more ad tags associated with the publisher system 112, pricing terms and payment data, and the like. A unique network identifier may be assigned to each publisher system 112.

After purchasing ad tags from the various publisher systems 112, the targeting system 100 may generate a list of publisher systems 112 available for advertising (operation 214). For example, the targeting system 100 may generate a list of all publisher systems 112 available for advertising, such as identification information for the networks, publications, and websites; available ad tags, pixel identifications, advertisement types, sizes, and locations; and pricing terms.

The publisher system 112 may also record the purchase or other association of the ad tags with the targeting system 100 (operation 216). For example, the publisher may note that an ad tag associated with a particular portion of a web page on a particular website has been purchased by the targeting system 100, and implement a process for presenting information according to various parameters. For example, the publisher system 112 may note that when a user 114 visits a page, the publisher system 112 should read information from the user 114's computer, such as information associated with conventional cookies. The publisher system 112 may then present information to the user 114 according to the user 114's information, parameters set by the targeting system 100, or other criteria, such as default settings in the event that no relevant information about user 114 is available. The publisher system 112 may also be set to perform any other relevant tasks, such as tracking impressions upon users 114, click-through rates, and the like. To facilitate the targeting process, the publisher system 112 may set up one or more accounts for the targeting system 100 to record relevant information, such as contact information, targeting processes and information, pricing information, and the like.

The advertisers 110 may use the targeting system 100 to provide information to users 114 via the publisher systems 112. The advertisers 110 may provide the information to be presented to the users 114 and/or provide access to such information. The advertisers 110 may also provide parameters or settings for providing the information to the users 114.

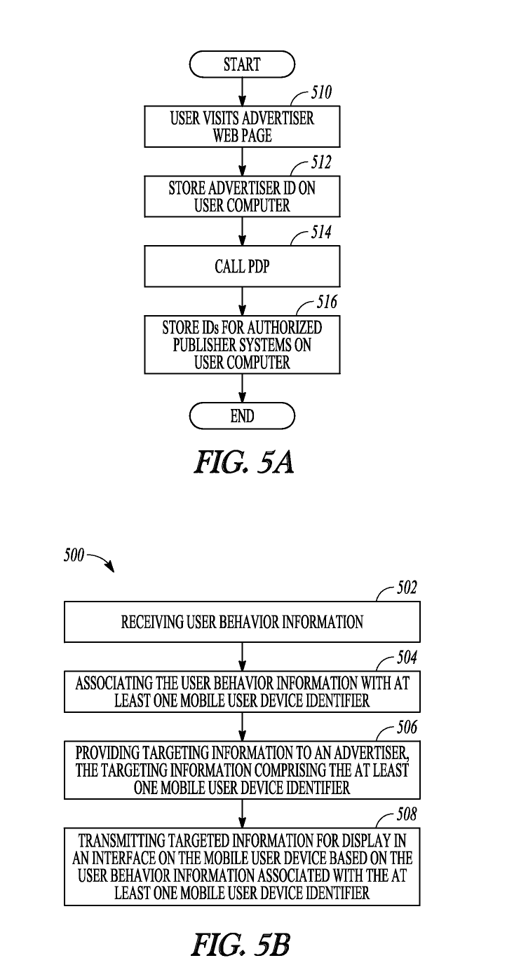

Referring to FIG. 3, the advertiser 110 may access an advertiser interface, such as a conventional web page associated with the targeting system 100, to set up or adjust an account (operation 310). Using information provided by the advertiser 110 or other parties, the targeting system 100 may create an account for the advertiser 110. The account may include any appropriate information, such as information relating to the advertiser 110, the advertiser 110's products or services, the information to be provided to users 114, an advertiser password, and/or payment information. The targeting system 100 may provide data and/or tools for use by the advertiser 110, such as targeting tools to identify users 114 that have visited the advertiser's 110 website and are to be selected for targeting.

The targeting system 100 may assign a username and a password to the advertiser 110 to give the advertiser 110 access to electronic account systems for providing relevant data. The targeting system 100 may request or require any relevant data to facilitate the targeting and related tasks, such as advertiser company information, payment information like credit card numbers or bank transfer numbers and amounts, and categories of goods and services to be provided. The targeting system 100 may also provide relevant data to the advertiser 110, such as balance information, targeting and advertising reports and analyses, and account status.

The advertiser 110 may also set up advertising information and parameters. For example, the advertiser 110 may identify domain names and websites from which targeting efforts are to be launched, set up advertising campaigns for targeting, select types of advertisements, and/or select particular publisher systems 112 for advertising. The advertiser 110 may provide, and/or the targeting system 100 may request or specify, any appropriate information to implement the targeting.

In one embodiment, the advertiser 110 provides information regarding the advertiser 110's website from which the targeting efforts are to be launched (operation 312). For example, the advertiser 110 may identify one or more websites and/or webpages by URL and may select from one or more categories of users 114 that are to be visiting the URLs (operation 314), such as users 114 shopping for pharmaceuticals, electronics, consumer goods, computer services, or the like. In the present embodiment, the advertiser 110 selects the appropriate category from a category tree for the website they want to target.

The advertiser 110 may also set up campaigns for the various offerings at the listed websites (operation 316). For example, a website for electronics products may set up one campaign for a particular DVD player and another campaign for a personal media player. Each campaign may be associated with various advertisers 110, selections, parameters, or other settings. For example, the advertiser 110 may select desired types of ads, such as skyscraper, leaderboard, banners, and so forth. The advertiser 110 may also submit the information itself, such as to add or change an image to be used as the advertisement for each type of ad. Alternatively, the advertiser 110 may provide information for retrieving the information, such as a URL at the advertiser 110's website, for retrieving the information. In the present embodiment, the advertiser 110 provides an ad for each type of ad to be presented to users 114 for each product or service associated with the various campaigns and websites (operation 318). The advertiser 110 may activate or deactivate the targeting campaign as well via the advertiser interface.

Each campaign may also be associated with pricing information (operation 320). For example, the targeting system 100 may facilitate flat payments, provide a bid system among multiple advertisers 110 for showing information at a particular website or other location, list average click prices, or other payment information. Various payment options may be made available to the advertisers 110 by the targeting system 100, and may vary according to any criteria, such as the size of the area, the page, publication, or publisher system 112 associated with a particular ad tag; the time of the presentation; or any other criteria or variables.

The targeting system 100 may also store any other appropriate information (operation 322). For example, different types of pages may be associated with different targeting strategies. For example, a default “landing page” for a campaign may be configured to target users 114 to purchase a particular product. A “success page,” corresponding to a user 114 purchasing the particular product, may be configured to target users 114 to purchase related products, such as accessories or improvements. The targeting system 100 may provide a default setting to exclude targeting of products that are associated with “success” page information on the user 114's computer (for example, to avoid showing an ad for a product that has already been sold to the user 114). Instead, the targeting system 100 may provide a different ad, such as for a related product or an improvement.

The advertiser 110 may also provide any other information relating to the campaigns. For example, the advertiser 110 may request a list of all available ad tags, such as by publisher system 112 and ad unit, and with corresponding prices, like average “click prices.” The advertiser 110 may then select which publisher systems 112, such as particular ad networks and publications, on which to advertise, with what type of ad campaigns, and/or how many times to show a particular user 114 a particular ad. The advertiser 110 may also make selections according to available ad units. For example, the targeting system 100 may not show skyscraper units if the advertiser 110 has not purchased any skyscraper ads. The targeting system 100 may list all available ad tags by network and ad unit, or may limit the type of ad tags according to criteria selected by the advertiser 110.

In addition, the advertiser 110 may provide frequency capping parameters, for example to restrict the number of times a particular user 114 is shown a particular ad, either overall or within a selected time period. The present targeting system 100 permits the advertiser 110 to control the frequency with which a user 114 is presented with the same information via multiple publisher systems 112. Further, the advertiser 110 may request reports regarding the campaign, such as total cost of the campaign, total clicks by day per ad campaign, average cost per click, total conversions (whether a click resulted in a lead, sale, purchase, etc.), total cost of conversions, and the like. The reports can provide information in any manner, such as by ad tag, website, or campaign.

The targeting system 100 may also provide targeting information and/or tools to the advertiser 110 to track users 114 for targeting purposes. The targeting information and/or tools may perform any appropriate tasks and include any appropriate information, such as identifying users 114 that visit any publisher system 112 associated with the targeting system 100 after visiting the advertiser's 110 website. The targeting information and/or tools may further indicate which product, service, or the like was previously viewed by the user 114, whether the user 114 purchased the viewed subject matter, how long ago the user 114 viewed the advertiser's 110 website, or any other information to facilitate targeting the user 114.

In one embodiment, the targeting system 100 provides targeting information including computer codes configured to place information on a user 114's computer to indicate that the user 114 visited the particular web page. For example, the targeting system 100 may provide one or more pixel drop codes (PDCs) to the advertiser 110 for each campaign to be placed on the advertiser 110's web pages (operation 324). The PDC places information on a user 114's computer upon visiting a website. The PDC may be given a name, such as the name of the associated campaign, and may be encrypted to ensure security. The PDC may include data unique to the targeting system 100, such as including an identifier for the targeting system 100, a unique identifier corresponding to the web site on which the PDC is placed, and/or any other appropriate components and data.

For example, each PDC may have an advertiser identifier corresponding to the advertiser 110, a product or service offered by the advertiser 110, a web page of the advertiser 110, or other identifier indicating that the user 114's computer received information relating to the advertiser 110. In one embodiment, the advertiser identifier includes a name associated with a particular campaign and/or web page, and may be configured to place a “cookie” or other data file on a user 114's computer. The cookie includes data referring to the targeting system 100 and the advertiser 110, such that when the cookie is identified by a publisher system 112, the publisher system 112 may recognize the cookie as being associated with the targeting system 100, and contact the targeting system 100 to retrieve the proper information to be provided to the user 114 according to the data and parameters for the particular advertiser 110.

After the advertiser 110 has set up the various campaigns on the targeting system 100 and placed the PDCs from the targeting system 100 on the appropriate webpages, users 114 may be targeted via the targeting system 100. Generally, the user 114 visits the advertiser 110's website, and the PDC places information on the user 114's computer, indicating which information was viewed by the user 114 at the advertiser 110's website, along with which publisher systems 112 should respond to the data placed by the PDC. The user 114 may then leave the advertiser 110's website, either with or without making a purchase or otherwise successfully performing a transaction.

When the user 114 visits a website connected with one of the publisher systems 112 associated with the targeting system 100, the publisher system 112 may determine whether it is among the publisher systems 112 selected by the advertiser 110 to respond to data placed by the PDC and proceed with targeting. If so, the publisher system 112 may notify the targeting system 100, which may provide the targeted information to the publisher system 112 for presentation to the user 114.

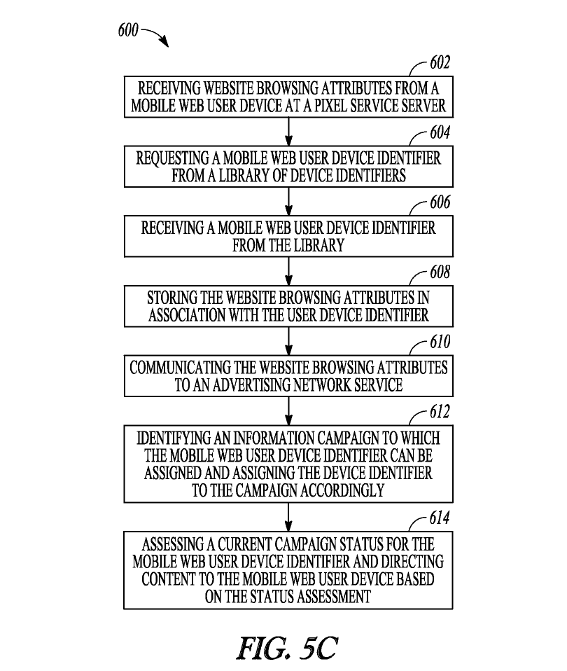

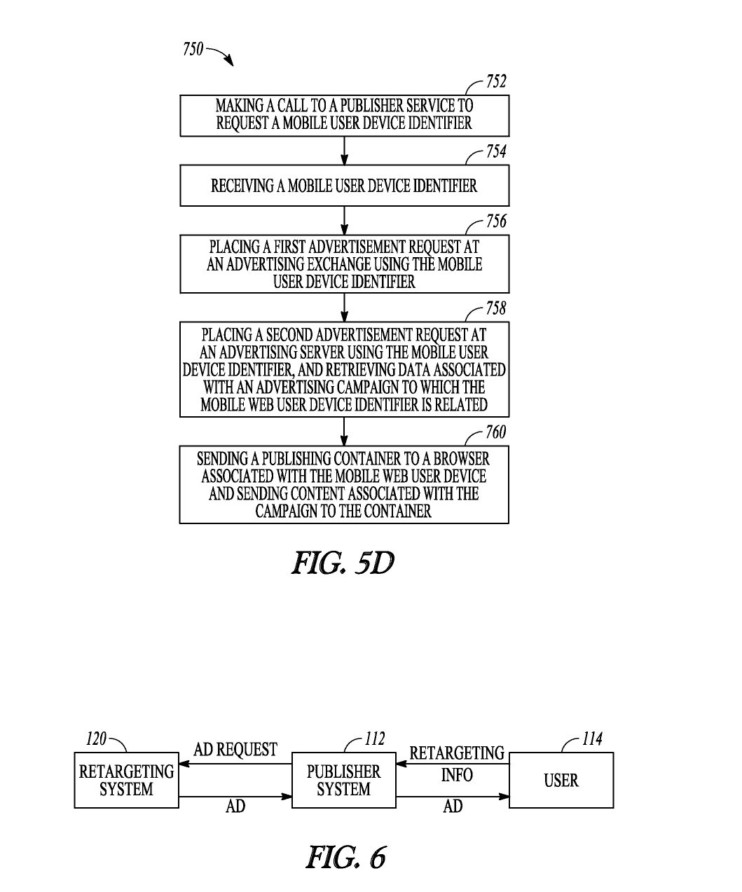

Referring to FIGS. 4 and 5A, for example, the user 114 may initially arrive at the advertiser 110's website and view various products (operation 510). When the user 114 downloads a page containing a PDC from the retargeting system 120, the PDC places targeting information, such as the advertiser identifier in the form of a cookie or other data, on the user 114's computer (operation 512). In the present embodiment, the cookie comprises an encrypted text file, and may include any suitable information, such as a website identifier corresponding to the web page visited by the user 114, a targeting system 100 identifier, and various other data, such as data corresponding to the selections and parameters provided by the advertiser 110 relating to the campaign and other parameters set by the targeting system 100.

The PDC may place the information on the user 114's computer in any suitable manner. For example, the PDC may comprise computer code to cause the user 114's computer to download information from another source, such as by calling a pixel drop page (PDP) associated with the targeting system 100 (operation 514). The PDP may reside on the targeting system 100's server 118 (FIG. 1), and may contain data provided by or relating to the various publisher systems 112, such as network pixels corresponding to each publisher system 112 associated with the targeting system 100. The PDP may receive an identifier for the PDC that called the PDP, which corresponds to a database entry for the campaign and website associated with the PDC.

The targeting system 100 may check the database for information to be provided to the user 114's computer, such as which publisher systems 112 have been selected to respond to perform targeting for the advertiser 110 via the targeting system 100. The targeting system 100 may then provide identification information for those publisher systems 112 authorized by the advertiser 110 to provide targeting on users 114 visiting the advertiser 110's web pages (operation 516). Thus, the targeting system 100 may include or exclude a particular publishing system's network pixel according to the information in the database regarding which publisher systems 112 were selected by the advertiser 110 to participate in the advertiser 110's targeting campaign.

The identities of the selected publisher systems 112, such as a set of network identifiers, may be placed on the user 114's computer, along with any other data selected by the advertiser 110 and/or the targeting system 100, such as the advertiser category selected by the advertiser 110, a website identifier, the PDC name, the type of PDC (like a “landing” or “success” PDC), the date the cookie was added, click-through rate information, an advertiser account identifier, a campaign identifier, an advertisement identifier, and/or any other desired or appropriate information. In the present embodiment, the PDC uses the information from the PDP to set the network pixels provided by the publisher systems 112 selected for participation by the advertiser 110 on the user 114's computer. For example, the cookie information may include the advertiser category, the website ID for the website placing the cookie information, the PDC name (including whether the page is a “landing” page, “success” page, or the like), the date the cookie information was added to the user 114's computer, click-through rate information, the advertiser account ID, the advertiser campaign ID, the ad ID, or other suitable information selected by the advertiser 110 and/or targeting system 100.

Placing the information on the user 114's computer facilitates tracking the pages viewed by user 114 or other actions for targeting. The user 114's action may be tracked in any appropriate manner, however, such as by saving the information and a user 114 identifier in the targeting system 100 database to determine the user 114's interactions with the advertisers 110 and the publisher systems 112.

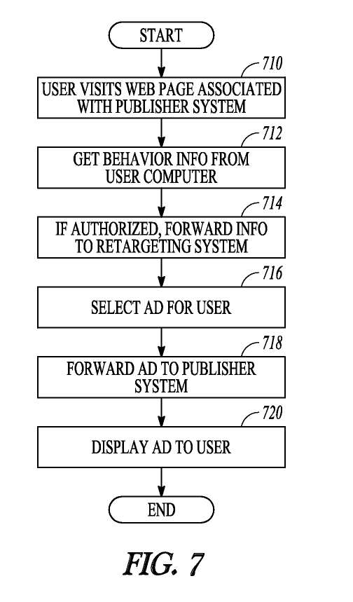

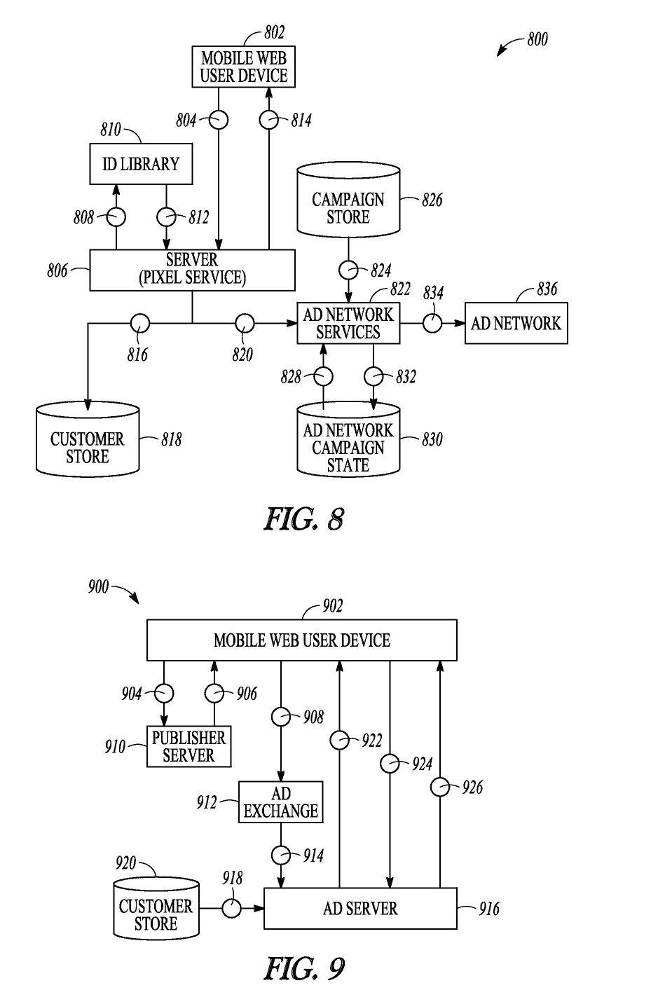

More particularly, the PDCs associated with each of the web pages associated with the advertiser 110 place information on the user 114's computer, including information relating to which publisher systems 112 have been selected to perform targeting. Eventually, referring to FIGS. 6-7, the user 114 may leave the advertiser's 110 web page and move to other websites (operation 710). If another website later visited by the user 114 is associated with one of the publisher systems 112 from which the retargeting system 120 has acquired targeting space, the publisher system 112 may retrieve the information placed by the advertiser 110 on the user 114's computer. If the publisher system 112 is one of those named to participate in the targeting, the publisher system 112 may retrieve an ad or other information associated with at least one of the advertiser 110 web pages visited by the user 114 from the targeting system 100 and present it to the user 114. The ad may be presented according to criteria set by the advertiser 110, the targeting system 100, and/or the publisher system 112.

In the present embodiment, the publisher system 112 may check the user 114's computer for user 114 behavior information, including the targeting information placed by the advertiser 110's web page, for example using conventional cookie-retrieval methods (operation 712). If the publisher system 112 recognizes the user 114 behavior information as including targeting information, such as a cookie from the targeting system 100, and if the retrieved information indicates that the publisher system 112 is among the publisher systems 112 selected by the advertiser 110 to perform targeting, the publisher system 112 contacts the targeting system 100 with the information from the user 114's computer (operation 714). The publisher system 112 may provide user 114 behavior information, as well as information regarding the publisher system 112, such as a publisher system 112 identifier, to facilitate tracking the targeting services provided by the publisher system 112. In the present embodiment, the publisher system 112 provides the ad category, website ID, PDC name, the date the cookie was added, the advertiser campaign ID, and the ad ID retrieved from the user 114's computer.

The information retrieved from the user 114's computer and received from the publisher system 112 may be processed by the targeting system 100 to target the user 114 according to the user 114's prior viewing of the advertiser 110's web pages. Based on the information from the user 114's computer and/or the information from the publisher system 112, the targeting system 100 of the present embodiment may identify an appropriate ad or other information to be provided to the user 114 via the publisher system 112 (operation 716). For example, the targeting system 100 may determine that the publisher system 112 has an ad tag for a banner ad available, and that the user 114 previously viewed a particular DVD player on the advertiser's 110 website. The targeting system 100 may then select a banner ad from the relevant advertiser 110 for the DVD player from the database and provide the banner ad to the publisher system 112 for presentation to the user 114.

If multiple candidate ads are available, the targeting system 100 may implement a set of preselected criteria to select which ad to provide to the publisher system 112. For example, the user 114 might have visited three different sites of three different advertisers 110, and only one ad tag may be available for presenting a targeted ad to the user 114. The targeting system 100 may select an advertiser 110 and ad to be presented according to the ad selection criteria. The ad selection criteria may relate to any appropriate criteria, such as the most recent web page visited by the user 114, a priority set by the advertiser 110, a bidding scheme, a priority in time, a predetermined hierarchy, or the like.

For example, the targeting system 100 may first identify the type of user 114 according to the user 114 category identified in the cookie information. The targeting system 100 may then identify all campaigns that match the category and exclude those that do not qualify, such as those campaigns that are not adequately funded, campaigns that do not include the proper ad type for the available ad tag, campaigns that have met a frequency cap, or campaigns associated with a “success” page cookie, indicating that the user 114 has already purchased the product. If the user 114 belongs to multiple categories, the targeting system 100 can select the ad according to selected arbitration criteria, such as the most recent user 114 activity. Thus, a user 114 may belong to both a flowers group and a mortgage group. If the user 114 was shopping for flowers yesterday and mortgages last week, the targeting system 100 may elect to select a flowers ad for presentation to the user 114.

Likewise, if multiple campaigns are available within the user 114's category, the targeting system 100 may select the campaign where the website ID owner is same as the one who created the cookie record match. Thus, if www.advertiser.com set the targeted information, then ads from that advertiser 110 will have priority. Similarly, if there are multiple matches, the targeting system 100 may select an ad corresponding to the most recent match. If the website ID has multiple campaign matches, the targeting system 100 may select the campaign with the highest effective cost per thousand (eCPM). If the eCPMs are even or unavailable, the targeting system 100 may select the ad at random. If the website ID owner does not have a valid campaign, the targeting system 100 may select the campaign with the highest eCPM. If there are multiple ads available, the ads may be rotated. Further, after a selected number of impressions have been delivered for each ad, the targeting system 100 may select the one with the highest CTR. Any appropriate selection criteria, however, may be applied.

The targeting system 100 may then send the selected ad for the selected advertiser 110 to the publisher system 112 (operation 718). The targeting system 100 may also store the information received from the publisher system 112, including the publisher system 112 identifier, and information regarding the response provided by the targeting system 100. The targeting system 100 may also charge the advertiser 110's account (for example, on an hourly basis). In the present embodiment, the targeting system 100 determines eCPM cost for traffic (via ad tag data) for each ad tag that has been delivered during that hour and determine clicks on the presented ads. Each advertiser account may have a margin percentage entered into its account. As a default setting, every account may include a 200% percentage. The targeting system 100 determines total cost by multiplying the fee charged by the publisher system 112 by the margin percentage for that account. Thus, if the total cost for the traffic during the hour for one ad tag is $10, the 200% margin percentage results in a charge of $20 to the advertiser 110. If the total clicks on the ad were 10, the cost per click is $2.00.

The publisher system 112 receives the ad and displays the ad to the user 114 (operation 720). The publisher system 112 may note that the ad was presented and provide a confirmation to the targeting system 100. This information may be used to charge the targeting system 100 for the services provided. The publisher system 112 may also note and/or transfer to the targeting system 100 any appropriate information, such as whether the user 114 acted upon presentation of the ad by clicking on it. The targeting system 100 may store information relating to the targeting process, such as which ads were presented to which users 114, the publishing systems that presented the ads, the costs associated with the targeting, which ads led to further action like a sale or lead, the types of ads presented, and the frequency with which ads were presented to particular users 114.

The targeting system 100 may also include a reporting system for reporting information and results, such as for data tracking and settling accounts. For example, the targeting system 100 may store information relating to the targeting services provided by the publisher system 112, such as the number of impressions of each ad provided by the publisher system 112 to users 114, the number of clicks by users 114 on those ads, and the like. The targeting system 100 may organize the information in any suitable manner, such as by advertiser 110, advertisement, ad tag, ad type, or campaign. The targeting system 100 and/or the advertiser 110 may compensate the publisher system 112 as well, such as on a per impression basis or a click-through rate basis. The reporting system may generate the appropriate reports for operating with the various publisher systems 112, such as to support the amounts owed to the publisher systems 112 for the provided services.

In addition, the reporting system may organize and report information relating to the advertisers 110, such as to track operations and support invoicing. For example, an advertiser 110 may have limited access to the reporting system to receive selected information. In the present embodiment, the advertiser 110 may request information regarding performance over selected date ranges, by ad tag, by website, by campaign, by publisher system 112, or according to other suitable parameters. The reporting system may generate charts, total amounts spent or owing, total clicks by day per ad campaign, average cost per click, total conversions (whether click resulted in lead, sale, purchase, etc.), total cost of conversions, prepaid amounts left in the advertiser 110's account, amounts paid to the publisher systems 112, or other relevant information. The reporting system may also reflect amounts paid or owed to the targeting system 100, such as on a per click basis, a click-through rate basis, or a multiplier of rate charged by the publisher systems 112.

In some further examples of the present subject matter, third party cookies may be blocked by default on IOS user devices. Sometimes a dynamic creative content is dependent on the cookie. Advertising network pixels may also be cookie dependent and rely on cookies for user identification. “Mobile web” and “application” publication or advertising systems may have different feature sets for mobile identification. Further, technologies such as the IOS Identifier for Advertising only work in application environments. In some examples, cookies may not allow for user identification and targeting on all platforms.

In some examples, technology providers (such as Ad Truth and Blue Cava) create device or user IDs, which in some examples are referred to as “non-cookie” IDs. Some networks (such as PayPal Media Network) are developing user targeting schemes that work within their domain using proprietary IDs. Server-side data stores can remove the dependency on cookies stores for providing the inputs to dynamic creative processes. A mixture of IDs is still needed as there are no known conventional standards for device IDs that work in all situations. Networks and technology providers are seeking to provide solutions that can link users, publishing systems, and advertisers across devices. The aforementioned device IDs, user IDs, or “non-cookie” IDs are generically termed “IDs” or “mobile user device identifiers” in the following description and claims.

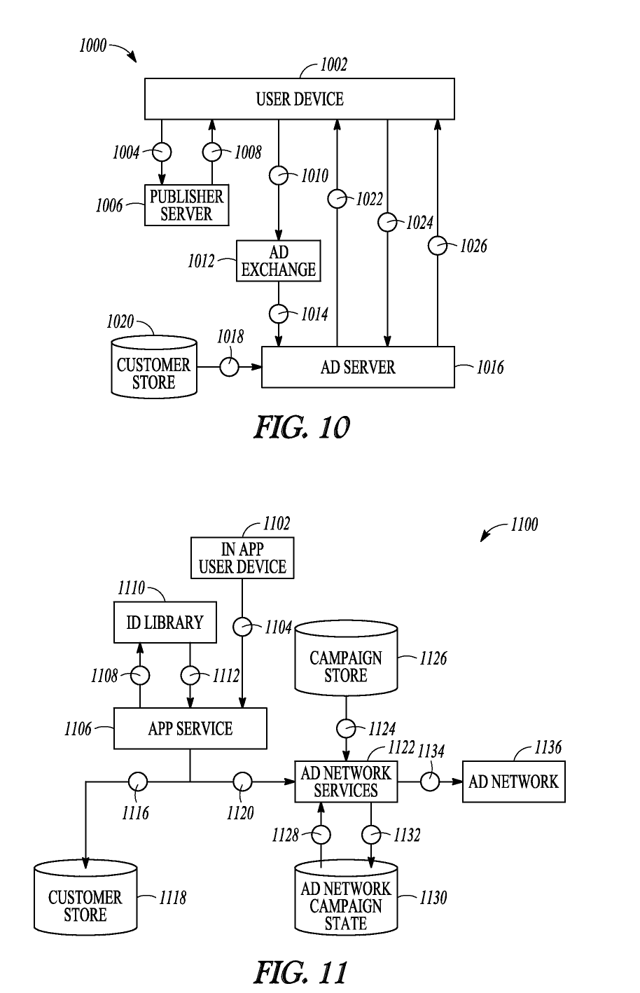

Reference is now made to FIG. 8 of the accompanying drawings which shows a system and process 800 for site tracking and campaign advertising for mobile web user devices 802. At operation 804, website browsing attributes are sent from a mobile web user device 802 to a server 806 (such as a pixel service). At operation 808, a request is made for an ID from a library 810 of IDs (such as a library provided or hosted by Ad Truth or Blue Cava). At operation 812, an ID is returned to the server 806. At operation 814, the ID is returned to the browser associated with the device 802. At operation 816, the site attributes are saved and associated with the returned ID in a database or customer store 818. At operation 820, the site activity is passed to an advertising network service 822 to determine what campaign a customer should be added to. At operation 824, campaigns for a site are retrieved from a campaign store database 826. At operation 828, a customer's current state of campaign is retrieved from an advertising network campaign state database 830. The term “customer” may be used interchangeably with the term “user” used elsewhere in this specification, as appropriate in context. At operation 832, if a customer's campaign state needs updating, the campaign state is updated accordingly. At operation 834, a server-to-server connection with an advertising network 836 is made to add or remove a customer from the campaign. An ID (of the type defined just above) is used as a customer key throughout the process.

Reference is now made to FIG. 9 of the accompanying drawings which shows a system and process 900 for mobile web advertisement serving. In the following description, the term “call” refers generally to a network communication, whether over the Internet or a cell network, for example. A mobile web user device 902 is shown. At operation 904, a publisher makes a call to a publisher server 910 to get a customer ID. At operation 906, an ID is returned. At operation 908, an advertising call request is made with the ID at an advertising exchange 912. At operation 914, an advertising call is made to an advertising server 916. At operation 918, campaign details for that customer are retrieved from a customer store or database 920. At operation 922, an advertising container is delivered to the browser associated with the user device 902. At operation 924, a creative request (request for creative content associated with the advertising) is made back to the advertising server 916. At operation 926, creative details are returned to the container now associated with the browser in the user device 902. An ID of the type defined above can be used throughout the above process in some examples.

Reference is now made to FIG. 10 of the accompanying drawings which shows a system and process 1000 for advertisement serving in user “application” (as opposed to web-based) environments. A mobile user device 1002 is shown. The device 1002 can run “applications” to access content and information. At operation 1004, a publisher makes a call to a publisher server 1006 to get an ID (as defined above). At operation 1008, an ID is returned. At operation 1010, an advertising call request is made with the ID at an advertising exchange 1012. At operation 1014, an advertising call is made to an advertising server 1016 and an ID is passed on. At operation 1018, campaign details for that customer are retrieved from a customer store or database 1020. At operation 1022, an advertising container is delivered to the browser associated with the user device 1002. In some examples, the delivery of the container relates to a static addition of content, while in other examples mobile rich media may be provided. At operation 1024, the ID is returned to the advertising server 1016, and a creative request is made back to the advertising server 1016. At operation 1026, creative details are returned to the container now associated with the browser in the user device 1002. An ID of the type defined above can be used throughout the above process in some examples. Note that in this example, a call to an ID library (e.g., library 810) is not necessarily needed. Customer or user IDs can be bridged later based on customer aspects being matched. As long as the ID can be linked to the ID in operation 1004, then the targeting can be done.

Reference is now made to FIG. 11 of the accompanying drawings which shows a system and process 1100 for site tracking and campaign advertising in user “application” (as opposed to web-based) environments. A mobile user device 1102 is shown. The device 1102 can run “applications” to access content and information. At operation 1104, application browsing attributes are sent from the user device 1102 to an application service 1106. In some examples, a user ID is passed, such as an Open UDID, IOS IFA, Android Id, MAC, or AdTruthId. Other identifiers are possible. At operation 1108, a request is made for an ID from a library 1110 of IDs (such as a library provided or hosted by Ad Truth or Blue Cava). At operation 1112, an ID is returned to the application service 1106. At operation 1116, the site attributes are saved and associated with the returned ID in a database or customer store 1118. At operation 1120, the site activity is passed to an advertising network service 1122 to determine what campaign a customer should be added to. At operation 1124, campaigns for a site are retrieved from a campaign store database 1126. At operation 1128, a customer's current state of campaign is retrieved from an advertising network campaign state database 1130. Here again, the term “customer” may be used interchangeably with the term “user” used elsewhere in this specification, as appropriate in context. At operation 1132, if a customer's campaign state needs updating, the campaign state is updated accordingly. At operation 1134, a server-to-server connection with an advertising network 1136 is made to add or remove a customer from the campaign. An ID is not needed in this scenario, but if an ID is used, it must match with the advertising network being utilized.

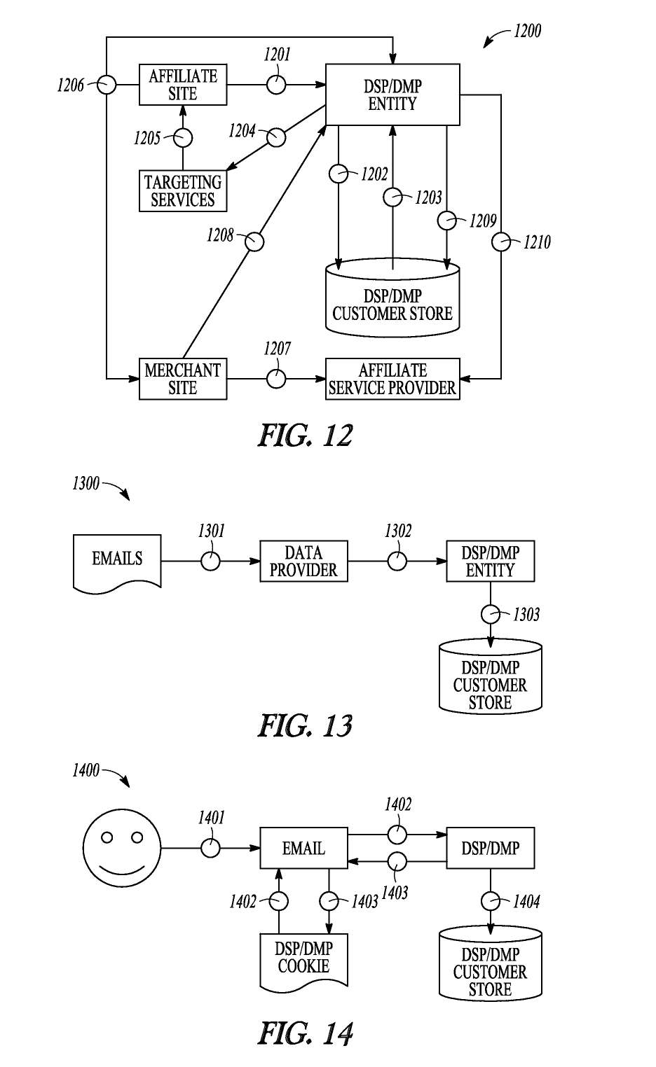

Reference is now made to FIGS. 12-14 of the accompanying drawings in connection with example embodiments of the present subject matter relating to dynamic affiliate commission payments for advertising. An affiliate site (such as blog) may be associated with a principal site. In one affiliate arrangement, an agreement may exist between two sites in which one site (the affiliate) agrees to feature content or an ad designed to drive traffic to another site. In return, the affiliate receives a percentage of sales or some other form of compensation generated by that traffic (see e.g., www.iab.net/wiki/index.php/Affiliate_marketing).

FIG. 12 depicts a process and system 1200 relating to an example affiliate offer flow. At operation 1201, a customer visits an affiliate site. Through a DSP/DMP (dynamic manager) publisher container, an advertising call request is made to a DSP/DMP entity. At operation 1202, the DSP/DMP does a lookup in its customer profile database based on a cookie (or non-cookie) ID. At operation 1203, the DSP/DMP customer profile database (or customer store) returns attributes such as new to file (or other attributes). At operation 1204, the DSP/DMP makes an advertising call to an information targeting service provider and passes parameters from the customer lookup (such as a creative macro). At operation 1205, the targeting service provider serves the creative content using dynamic manager rules that use the customer parameters. At operation 1206, the customer clicks-through to the merchant (or principal) site and converts (i.e., pays for a good or a service at the merchant site). A beacon could also be fired to track and target such click-throughs. At operation 1207, an affiliate service provider such as Pepperjam Exchange (www.pepperjam.com) receives conversion data from the Merchant site. In some examples, the service provider may drop the DSP/DMP conversion pixel as well. In some examples, the DSP/DMP beacon should be called on all conversions. At operations 1208 and 1209, the DSP/DMP entity stores conversion data and an affiliate service provider cookie (or non-cookie) ID. At operation 1210, the DSP/DMP entity sends a feed to the affiliate service provider with customer attributes. The affiliate service provider computes a commission using rules based on attributes in the feed. In some examples, commission payments vary based on whether the user is a new or existing customer of the affiliate site.

Reference is now made to FIG. 13 of the accompanying drawings. This view depicts a flow 1300 of email IDs in a batch flow environment. At operation 1301, a merchant submits an email list to a data provider on a recurring basis. At operation 1302, the data provider does a lookup of email addresses and matches these to DSP/DMP cookies at a DSP/DMP entity. The data provider could be eBay Trinity or another company such as LiveRamp. In some examples, a cookie synchronization process may be needed between the data provider and the DSP/DMP entity. At operation 1303, the DSP/DMP entity stores attributes based on the email lookup.

Reference is now made to FIG. 14 of the accompanying drawings. The cookie synchronization process could link, for example, eDialog and FetchBack IDs (as a DSP/DMP entity) for a customer. This linking would allow data to be retrieved and integrated into FetchBack's customer database by using a server-to-server integration between eDialog's and FetchBack's servers.

At step 1401, a customer opens an email. At steps 1402, a pixel call is made to FetchBack DSP/DMP that includes the eDialog ID for the customer. If the FetchBack DSP/DMP cookie exists, it is also read and passed to FetchBack DSP/DMP. In some examples, different beacons could be dropped based on information on the customer known in the ESP. At steps 1403, if the FetchBack DSP/DMP cookie does not exist, then one is created and returned with the FetchBack/FetchBack DSP/DMP ID. At step 1404, an entry is made in the FetchBack DSP/DMP Customer Database that links the FetchBack DSP/DMP ID and the eDialog ID for the customer.

In an example affiliate advertising campaign setup, an account is set up within the DSP/DMP entity and a targeting service provider for an affiliate site (see FIG. 12 for examples of such entities). The DSP/DMP entity creates a publisher container that is placed on the affiliate site. A campaign is created within the targeting service provider. Any creative assets associated with an affiliate site offer are uploaded into the targeting service provider. A dynamic manager may be used to set up multiple offers. Offers may vary by customer attributes, time, and so forth. A campaign is set up in the DSP/DMP entity. A creative tag is created in the targeting service provider that has an impression tracking pixel from the DSP/DMP entity and the creative assets. The tag is uploaded into the DSP/DMP entity. A beacon pixel may be created in the DSP/DMP entity. A pixel from an affiliate service provider (such as Pepperjam Exchange) may be set up to fire the DSP/DMP beacon event on conversions (i.e., the purchase of goods or services). A Pepperjam Exchange, for example, may set up rules for commissions based on the feed from the DSP/DMP entity.

In some specific use examples, since a FetchBack ID (i.e., an ID from a targeting service provider) will be synchronized with another site like eBay, real-time calls are made to service providers such as Trinity to determine aspects such as “New to file,” “Last purchase date,” and “Usage of PayPal” (or not). Other use cases for which offers to show and how affiliates should be compensated could be controlled via these values. This can be done without Trinity, through the use of alternate service providers such as LiveRamp, for example. Other data could also be used to control the offers. For example, BestBuy offers could be based on marketplaces activity as well. Other purchase behaviors may be identified. For example, instead of a batch feed to a DSP/DMP entity, commissions could be based on parameters set in the click URLs of the advertisements.

In a multiple offers use case, for a select group of affiliates, a merchant (such as Best Buy) may want to dynamically pay affiliates based on delivering “new to file” customers. A campaign plan may include setting up two offers such as a standard 10% commission and a “10% off” deal for “new to file” customers. A 3% commission and Free Shipping may be applied for returning customers. In execution of the campaign, the offer may be shown on affiliate sites. Customers may be linked because of an online email cookie match (of the type described further above) or an offline email match using a data provider. A FetchBack dynamic manager, for example, may allow the offer to be flexibly controlled based on customer attributes.

In an eBay partner use case, an eBay partner network may wish to start extending coupons to non-eBay users through an affiliate channel to a select group of partners. The campaign may include creation of an exclusive eBay coupon that is shown only to users that have not recently purchased on eBay. In execution, an offer may be shown based on aspects such as a data interchange with eBay sufficient to identify “new to file” customers. A FetchBack dynamic manager, for example, may allow the offer to be flexibly controlled based on customer attributes.

With above descriptions in mind, any of the machines, repositories, or devices described herein may be used or configured partially or entirely as appropriate to perform one or more of the methods, operations, or functions described herein, or as set forth below in the following operations. Other devices or systems may be employed. Some examples of the present disclosure include methods.

One such method is illustrated in FIG. 5B. In this example embodiment, a method 500 includes: at block 502, receiving user behavior information; at block 504, associating the user behavior information with at least one mobile user device identifier; at block 506, providing targeting information to an advertiser, the targeting information comprising the at least one mobile user device identifier; and, at block 508, transmitting targeted information for display in an interface on the mobile user device based on the user behavior information associated with the at least one mobile user device identifier.

Another method is illustrated in FIG. 5C. In this example embodiment, a method 600 includes: at block 602, receiving website browsing attributes from a mobile web user device at a pixel service server; at block 604, requesting a mobile web user device identifier from a library of device identifiers; at block 606, receiving a mobile web user device identifier from the library; at block 608, storing the website browsing attributes in association with the user device identifier; at block 610, communicating the website browsing attributes to an advertising network service; at block 612, identifying an information campaign to which the mobile web user device identifier can be assigned and assigning the device identifier to the campaign accordingly; and, at block 614, assessing a current campaign status for the mobile web user device identifier and directing content to the mobile web user device based on the status assessment.

Another method is illustrated in FIG. 5D. In this example embodiment, a method 750 includes: at block 752, making a call to a publisher service to request a mobile user device identifier; at block 754, receiving a mobile user device identifier; at block 756, placing a first advertisement request at an advertising exchange using the mobile user device identifier; at block 758, placing a second advertisement request at an advertising server using the mobile user device identifier, and retrieving data associated with an advertising campaign to which the mobile web user device identifier is related; and, at block 760, sending a publishing container to a browser associated with the mobile web user device and sending content associated with the campaign to the container.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

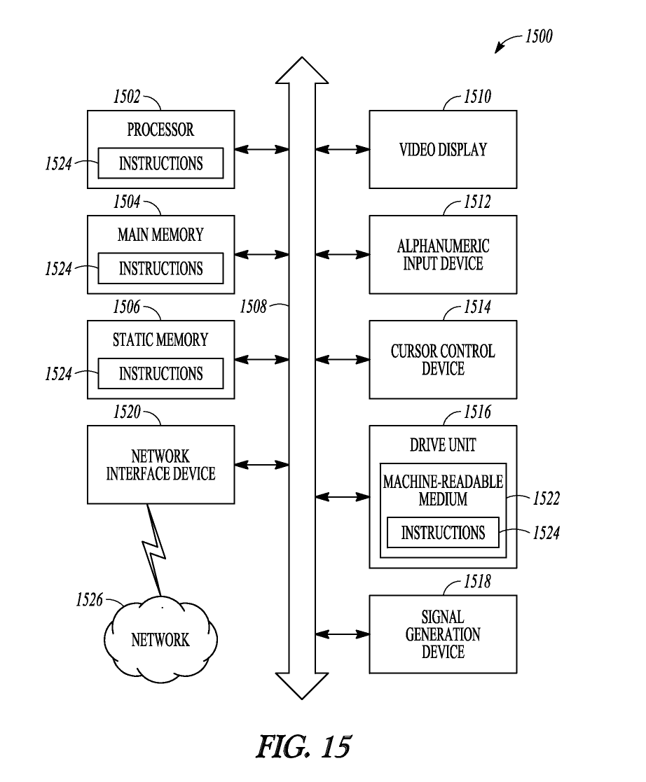

FIG. 15 is a block diagram of a machine in the example form of a computer system 1500 within which instructions 1524 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU), or both), a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 1500 also includes an alphanumeric input device 1512 (e.g., a keyboard), a user interface (UI) navigation (or cursor control) device 1514 (e.g., a mouse), a disk drive unit 1516, a signal generation device 1518 (e.g., a speaker), and a network interface device 1520.

### Machine-Readable Medium

The disk drive unit 1516 includes a machine-readable medium 1522 on which is stored one or more sets of data structures and instructions 1524 (e.g., software) embodying or used by any one or more of the methodologies or functions described herein. The instructions 1524 may also reside, completely or at least partially, within the main memory 1504, static memory 1506, and/or within the processor 1502 during execution thereof by the computer system 1500, with the main memory 1504 and the processor 1502 also constituting machine-readable media.

While the machine-readable medium 1522 is shown in an example embodiment to be a single medium, the term “machine-readable medium” may include a single medium or multiple media (e.g., a centralized or distributed database, and/or associated caches and servers) that store the one or more instructions 1524 or data structures. The term “machine-readable medium” shall also be taken to include any tangible medium that is capable of storing, encoding or carrying instructions for execution by the machine and that cause the machine to perform any one or more of the methodologies of the present subject matter, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 1524 may further be transmitted or received over a communications network 1526 using a transmission medium. The instructions 1524 may be transmitted using the network interface device 1520 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

Although the present subject matter has been described with reference to specific example embodiments, it will be evident that various modifications and changes may be made to these embodiments without departing from the broader spirit and scope of the subject matter. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

In the foregoing specification, the subject matter has been described with reference to specific exemplary embodiments. Various modifications and changes may be made without departing from the scope of the present subject matter as set forth in the claims. The specification and figures are illustrative, rather than restrictive, and modifications are intended to be included within the scope of the present subject matter. Accordingly, the scope of the subject matter should be determined by the claims and their legal equivalents rather than by merely the examples described.

For example, the steps recited in any method or process claims may be executed in any appropriate order and are not limited to the specific order presented in the claims. Additionally, the components and/or elements recited in any apparatus claims may be assembled or otherwise operationally configured in a variety of permutations and are accordingly not limited to the specific configuration recited in the specification and shown in the drawings.

Benefits, advantages, and solutions to problems have been described above with regard to particular embodiments. Any benefit, advantage, or solution to a problem or any element that may cause any particular benefit, advantage or solution to occur or to become more pronounced are not to be construed as critical, required, or essential features or components of any or all the claims.

As used in this description, the terms “comprise,” “comprises,” “comprising,” “having,” “including,” “includes,” or any variation thereof, are intended to reference a non-exclusive inclusion, such that a process, method, article, composition, or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present subject matter, in addition to those not specifically recited, may be varied or otherwise particularly adapted to specific environments, manufacturing specifications, design parameters or other operating requirements without departing from the general principles of the subject matter.

1. A system comprising:
a memory; and
at least one module, executing on one or more computer processors, to:
receive user behavior information;
associate the user behavior information with at least one mobile user device identifier;
provide targeting information to an advertiser, the targeting information comprising the at least one mobile user device identifier; and
transmit targeted information for display in an interface on a mobile user device based on the user behavior information associated with the at least one mobile user device identifier.

2. The system of claim 1, wherein the user behavior information is received from a visited publisher system, and wherein the targeting information further comprises multiple identifiers for multiple publisher systems for targeting by the advertiser.

3. The system of claim 2, wherein the memory stores:
the identifiers for the multiple publisher systems;
the targeting information; and wherein
the at least one module is further to provide the targeting information to the advertiser, receive the user behavior information, and transmit the targeted information to the mobile user device.

4. The system of claim 3, wherein the targeting information includes code to request the multiple publisher system identifiers from the memory.

5. The system of claim 2, wherein the multiple publisher systems comprise at least two unrelated ad networks.

6. A computer-implemented method comprising:
receiving user behavior information;
associating the user behavior information with at least one mobile user device identifier;
providing targeting information to an advertiser, the targeting information comprising the at least one mobile user device identifier; and
transmitting targeted information for display in an interface on the mobile user device based on the user behavior information associated with the at least one mobile user device identifier.

7. The method of claim 6, wherein the user behavior is received from a visited publisher system, and wherein the targeting information further comprises multiple identifiers for multiple publisher systems for targeting by the advertiser.

8. A non-transitory machine readable medium, including instructions, which when performed by a machine, causes the machine to perform operations including:
receiving user behavior information;
associating the user behavior information with at least one mobile user device identifier;
providing targeting information to an advertiser, the targeting information comprising the at least one mobile user device identifier; and
transmitting targeted information for display in an interface on a mobile user device based on the user behavior information associated with the at least one mobile user device identifier.

9. The non-transitory medium of claim 8, wherein the user behavior information is received from a visited publisher system, and wherein the targeting information further comprises multiple identifiers for multiple publisher systems for targeting by the advertiser.

10. A system comprising:
a memory; and
at least one module, executing on one or more computer processors, to:
receive website browsing attributes from a mobile web user device at a pixel service server;
request a mobile web user device identifier from a library of device identifiers;
receive a mobile web user device identifier from the library;
store the website browsing attributes in association with the user device identifier;
communicate the website browsing attributes to an advertising network service;
identify an information campaign to which the mobile web user device identifier can be assigned and assigning the device identifier to the campaign accordingly; and
assess a current campaign status for the mobile web user device identifier and direct targeted information to the mobile web user device based on the status assessment.

11. The system of claim 10, wherein the website browsing attributes are received from a visited publisher system, and wherein the status assessment includes a review of multiple identifiers for multiple publisher systems for targeting by an advertiser in the information campaign.

12. The system of claim 11, wherein the memory stores:
the identifiers for the multiple publisher systems;
the website browsing attributes; and wherein
the at least one module is further to provide the identifiers to the advertiser, receive the website browsing attributes, and transmit the targeted information to the mobile user device.

13. The system of claim 12, wherein communicating the website browsing attributes to the advertising network service further includes requesting the multiple publisher system identifiers from the memory.

14. The system of claim 11, wherein the multiple publisher systems comprise at least two unrelated ad networks.

15. A computer-implemented method comprising:
receiving website browsing attributes from a mobile web user device at a pixel service server;
requesting a mobile web user device identifier from a library of device identifiers;
receiving a mobile web user device identifier from the library;
storing the website browsing attributes in association with the user device identifier;
communicating the website browsing attributes to an advertising network service;
identifying an information campaign to which the mobile web user device identifier can be assigned and assigning the device identifier to the campaign accordingly; and
assessing a current campaign status for the mobile web user device identifier and directing content to the mobile web user device based on the status assessment.

16. A computer-implemented method comprising:
making a call to a publisher service to request a mobile user device identifier;
receiving a mobile user device identifier;
placing a first advertisement request at an advertising exchange using the mobile user device identifier;
placing a second advertisement request at an advertising server using the mobile user device identifier, and retrieving data associated with an advertising campaign to which the mobile user device identifier is related; and
sending a publishing container to a browser associated with a mobile user device and sending content associated with the campaign to the publishing container.
